(19) United States
(12) Patent Application Publication
(10) Pub. No.: US 2010/0212170 A1
(43) Pub. Date: Aug. 26, 2010

(54) Laser Line Convergence Vehicle Alignment System

(76) Inventor: Shawn Marsee, Cape Canaveral, FL (US)

Correspondence Address: HAYWORTH, CHANEY & THOMAS, P.A., 202 N. HARBOR CITY BLVD., SUITE 300, MELBOURNE, FL, 32935, US

(21) Appl. No.: 12/712,786

(22) Filed: Feb. 25, 2010

Related U.S. Application Data
(60) Provisional application No. 61/208,631, filed on Feb. 26, 2009.

(51) Int. Cl. G01B 7/30

(52) U.S. Cl. 33/288; 73/1.75

(57) ABSTRACT

A system for aligning a vehicle to an object and a method for calibrating same is disclosed. The system comprises three light sources which are calibrated when the vehicle and object are in desired alignment. After initial calibration, the light sources project images which converge in a predetermined configuration on a reflecting surface. The reflecting surface is positioned in a fixed location relative to the object to which the vehicle is being aligned. The convergence of the projected images indicates to the operator of the vehicle that the vehicle and the object are in desired alignment. The light sources may be rotatably attached to the vehicle such that the roll, pitch, and yaw of each light source may be adjusted during calibration.

### CROSS REFERENCE TO RELATED APPLICATIONS

This application claims the benefit of provisional patent application Ser. No. 61/208,631, filed with the USPTO on Feb. 26, 2009, which is herein incorporated by reference in its entirety.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISK

Not applicable.

### BACKGROUND OF THE INVENTION

1. Field of the Invention

The present invention generally relates to aligning a vehicle to a stationary object, more specifically, the present invention relates to aligning a trailer hitch to a trailer while backing up a vehicle or aligning a truck to a delivery dock while backing up a vehicle.

2. Background Art

It is frequently necessary to accurately position a vehicle with respect to a stationary object. Such stationary object can be a physical structure such as a garage, but also a trailer, a loading dock, and the like. Vehicles which require such precise positioning may include any means of conveying people or cargo on land, on sea, or in the air. Examples of situations in which the accurate positioning of a vehicle may be desired include the garaging or a car, the positioning of a truck at a loading dock, the docking of a boat at a slip, the positioning of a trailer hitch with respect to a trailer, and the positioning of an airplane at a passenger or baggage terminal. In all of these cases, along with similar cases too numerous to mention, an operator must accurately guide the vehicle along a pathway bringing it to a defined position in relationship to surrounding stationary structures, objects, or spaces.

It is not uncommon for damage to occur to the vehicle or surrounding objects during the positioning process. For example, in positioning a vehicle relative to a trailer, contact of the vehicle's bumper with trailer is a more than likely occurrence which could result in damage to both the vehicle and the trailer. Moreover, the initial positioning of the vehicle relative to the object may be unsatisfactory. If this is the case, the positioning operation may have to be repeated; thereby, leading to the possibility that damage will occur again during repositioning. Alternatively, if repositioning is not performed, other consequential problems, such as difficulty in unloading cargo or connecting a trailer to a hitch frequently arise. These and other problems inherent in vehicular positioning operations are well recognized and various devices and techniques have been envisioned or devised to overcome such problems.

Problems arise associated with the specific instance of connecting a vehicle to a trailer. These problems may be similar to those encountered when aligning a vehicle to a loading dock or other stationary object. There are numerous different hitches that are used to attach a trailer to a vehicle to enable the vehicle to tow the trailer. A few popular hitches include a “bumper ball hitch,” a “gooseneck hitch,” and a “fifth-wheel hitch.” A bumper ball hitch comprises a ball attached to the bumper of vehicle that fits within a corresponding socket located on a trailer. A gooseneck hitch also uses a ball located on a vehicle to engage a socket mounted on the trailer. But, the ball is mounted on the body of the vehicle, typically the bed of a pick-up truck, as opposed to the vehicle's bumper.

A fifth-wheel hitch is similar to a gooseneck hitch in that the section of the hitch attached to the vehicle is placed within the center of the truck bed and this section of the hitch includes a receiver (or other type of joint) that fits into a pin located on the section of the hitch attached to the trailer. But, a fifth-wheel hitch is different from a gooseneck and bumper ball hitch because it includes a large mounting mechanism that elevates the receiver (or other type of joint) above the bed of the truck.

All of these hitches have certain advantages and disadvantages and are typically used with certain trailers to perform specific tasks. For example, while a bumper ball hitch is excellent for towing a boat on a trailer, it isn't always appropriate to tow a large camper. Conversely, while a fifth-wheel hitch is an excellent choice to tow a large trailer such as a camper or RV, it usually won't function well to tow a boat. Therefore, a user might use a single vehicle to tow various trailers that have different hitches and have a bumper ball and a gooseneck or fifth-wheel hitch attached to the same vehicle to accommodate all of his towing needs.

One of the biggest problems associated with each of these hitches (bumper ball, gooseneck, and fifth-wheel) is properly aligning the ball with the socket (or the pin with the receiver for fifth-wheel hitch). The vehicle must be perfectly positioned so that the ball is located directly under the socket. Once aligned, the socket is lowered to engage the ball. Unfortunately, positioning the vehicle in the precise location to place the ball directly under the socket is very difficult, as the ball and socket are usually obstructed from a user's view. If the user fails to align the ball with the socket, the vehicle or trailer can be damaged if the socket or ball strikes the surface of the vehicle or trailer. This type of damage is particularly common with a bumper ball hitch and can result in a bent or punctured bumper.

To prevent vehicle damage and to help align the ball and socket, some users enlist the help of another person who stands behind the vehicle and directs the user to move either forward or backward and left or right until the ball is located directly under the socket. But, this method requires that another person be available and willing to help the user. Additionally, this method isn't practical at night because the other person must have a clear view of the ball and socket, which are not easy to see in the dark.

Other users will attempt to get as close as they can, then park the vehicle and walk to the bed or bumper to see how close they got. The user will then get back in the vehicle and reposition it based upon the results of the first attempt. This method usually takes several attempts at aligning the ball and socket before it is successful.

Another common technique used to assist in the positioning of a vehicle is the erection of physical barriers (bollards) or bumpers which contact the vehicle as it deviates from the desired path. Such existing devices and techniques have at least two major drawbacks. First, they do not assist in guiding the vehicle to the correct position. On the contrary, actual impact is the first indication to the vehicle operator that the position of the vehicle is unacceptable. Second, the device may inflict damage on the vehicle and may even be damaged itself.

Another drawback of some known alignment devices is that they only function well when the vehicle is extremely close to the trailer. Specifically, certain known alignment devices only begin to function when the vehicle is a few feet away from the trailer. This can cause the driver to hit the trailer with the vehicle while attempting to get the alignment device in range to function.

Therefore, it is an object of the present invention to provide a vehicle alignment system, which can be used to align a vehicle with an object, that begins to assist the driver in aligning the vehicle with the object when the vehicle is several yards away from the object. It is also an object of the present invention to provide a vehicle alignment system that functions well in the dark, and is adjustable to work with any object to which the vehicle may be aligned. It is a further object of the present invention to provide a vehicle alignment system to quickly, accurately, and interactively guide a vehicle, leading it to the precisely desired position. It is yet a further object of the present invention to provide a vehicle alignment system that can easily be calibrated to operate with any object.

### BRIEF SUMMARY OF THE INVENTION

The invention comprises at least three (3) lasers which may be attached to a vehicle. The lasers are used to align the vehicle to an object. In a preferred embodiment, the lasers may be permanently or temporarily attached to a vehicle. In an alternate embodiment, the lasers may be attached to the object to which the vehicle is to be aligned. At least two (2) of the lasers may be capable of projecting an image onto a reflecting surface. The projected images may be lines, single points of light, crosshairs, or the like. The projected image may be pulsed on and off or continuously on. In preferred embodiments, the reflecting surface may be a boat hull, a garage wall, a gate, a loading dock, a trailer, a camper, an item attached to a trailer, an industrial reflector attached to a stationary object, or any other item that the vehicle driver is trying to position the vehicle relative to. In alternate embodiments, in which the lasers are attached to the object to which the vehicle is being aligned, the reflecting surface may be attached to the vehicle itself.

The lasers may be positioned on the vehicle or on the object to which the vehicle is aligning such that, as the vehicle approaches the desired alignment with respect to the reflecting surface, the projected images converge toward a predetermined configuration. When the vehicle is positioned in the desired alignment relative to the reflecting surface, the projected images visually indicate the proper alignment of the vehicle relative to the reflecting surface by displaying a distinctive predetermined configuration. Once the projected images have converged, the vehicle will be lined up at precisely the desired alignment relative to the reflecting surface. The convergence of the projected images signals the driver of the vehicle that the vehicle is in desired alignment with the object.

Alignment of the projected images will be determined by visual inspection. When the lasers converge, the predetermined configuration on the reflecting surface may be a shape similar to an “X”, “*”, “Y”, “+”, or the like. Optical lenses may be used in conjunction with the lasers such that the projected image may be a picture or any arbitrary design or pattern.

One laser may be mounted on the center line of the vehicle and point directly toward the rear of the vehicle. The laser on the centerline of the vehicle may project a first image directly behind the vehicle. This first image may be used to keep the vehicle lined up with the reflecting surface as the vehicle is backing up. The driver may maintain the first image on the reflecting surface while backing up the vehicle until the projected images produced by other lasers mounted off the centerline of the vehicle come into the driver's view on the reflecting surface. When the driver sees the projected images begin to converge, the driver may decrease the vehicle's velocity as the projected images converge to the predetermined configuration. Once the projected images converge to the predetermined configuration, the vehicle is at the desired alignment with respect to the object.

The lasers may be held in place by brackets, such as, for example, spherical bearing assemblies, or some other housing well known in the art, which may attach to a mounting rod. The brackets may have the ability to be moved towards the centerline of the vehicle, or away from the centerline of the vehicle. This feature may allow the user to move the lasers to enable the driver to better see the projected image(s). For example, if there is an obstruction, such as a boat trailer winch, which blocks the projected image from reaching the reflecting surface, then the user can adjust the laser closer to or further from the centerline so that the obstruction will not inhibit the projected image from reaching the reflecting surface. The further the lasers are moved away from the center line of the vehicle, the greater the angle will be with the center laser line at the point where the lasers converge. This will change the rate at which the laser lines converge from the driver's perspective while the vehicle is backing up.

The brackets which hold the laser may make use of a spherical bearing assembly type of mechanical connection such as rod ends, ball and socket joint, or the like. The laser may be attached or inserted into the ball portion of the connection so that the user can point the laser to best suit the application. The laser may then be moved in yaw, pitch, and roll. Such a configuration may allow the lasers to be calibrated for a particular application. For example, the user may take a laser that projects a vertical line and adjust the roll of the ball so that the line will be horizontal, adjust the pitch of the ball so that the line is displayed higher, or adjust the yaw of the ball so that the line is displayed further to the left. After the user has adjusted the laser so that the laser line is projected onto the reflecting surface at the desired location, a set screw in the housing may be tightened until it makes contact with the sphere or laser, thus locking the laser in place. This method may be repeated for each laser in its bracket, and the brackets may be secured on the vehicle at the desired location of the user.

After the lasers are aligned in this manner, the driver of the vehicle may align the vehicle with the reflecting surface merely by turning on the lasers and backing up the vehicle until the lasers converge into the predetermined configuration that was displayed at the time of the first laser line alignment. The lasers may be turned on remotely or by physically operating a switch connected to the laser assembly.

In accordance with one embodiment, the vehicle alignment system may be calibrated by positioning a vehicle in desired alignment with an object having a reflecting surface; attaching to the vehicle a first light source capable of projecting a first image; attaching to the vehicle a second light source capable of projecting a second image; attaching to the vehicle a third light source capable of projecting a third image; adjusting position of the first light source such that the first image appears at a first desired position on the reflecting surface; adjusting position of the second light source such that the second image appears at a second desired position on the reflecting surface; and adjusting position of the third light source such that the third image appears at a third desired position on the reflecting surface, wherein the first image, the second image, and the third image form a predetermined configuration when the vehicle is in the desired alignment with the object.

In accordance with another embodiment, the invention comprises a system for aligning a vehicle to an object comprising: a reflecting surface positioned relative to an object; a first light source capable of projecting a first image, the first light source attached to the vehicle and positioned such that the first image is displayed on the reflecting surface when the vehicle and the object are in desired alignment with one another; a second light source capable of projecting a second image, the second light source attached to the vehicle wherein the second light source is positioned such that the second image is displayed on the reflecting surface and the first image and the second image converge when the vehicle and the object are in the desired alignment with one another; and a third light source capable of projecting a third image, the third light source attached to the vehicle wherein the third light source is positioned such that the third image is displayed on the reflecting surface and the first image, the second image, and the third image converge to form a predetermined configuration when the vehicle and the object are in the desired alignment with one another.

In accordance with yet another embodiment, the invention comprises a system for aligning a vehicle to an object comprising: a first light source capable of projecting a first image wherein the first light source is adjustably attached to a mounting rod wherein the mounting rod is capable of attaching to the vehicle; a second light source capable of projecting a second image wherein the second light source is adjustably attached to the mounting rod; and a third light source capable of projecting a third image wherein the third light source is adjustably attached to the mounting rod wherein the first image, the second image, and the third image may converge to form a predetermined configuration when the vehicle and the object are in desired alignment with one another.

### BRIEF DESCRIPTION OF THE DRAWINGS

A better understanding of the present invention will be realized from the detailed description that follows, taken in conjunction with the accompanying drawings, in which:

FIG. 1 depicts an aerial view of the laser line convergence vehicle alignment system in combination with a vehicle and a trailer.

FIG. 2 depicts a side view of a spherical bearing assembly.

FIG. 3 depicts a perspective view of the laser line convergence vehicle alignment system in combination with a vehicle.

FIG. 4 depicts a view of the first image, second image, and third image on the reflecting surface when the vehicle is not aligned with the object.

FIG. 5 depicts a view of a predetermined configuration of the first image, second image, and third image on the reflecting surface when the vehicle is in desired alignment with the object.

### DETAILED DESCRIPTION OF THE INVENTION

Although the following detailed description contains many specifics for the purposes of illustration, anyone of ordinary skill in the art will appreciate that many variations and alterations to the following details are within the scope of the invention. Accordingly, the following preferred embodiments of the invention are set forth without any loss of generality to, and without imposing limitations upon, the claimed invention.

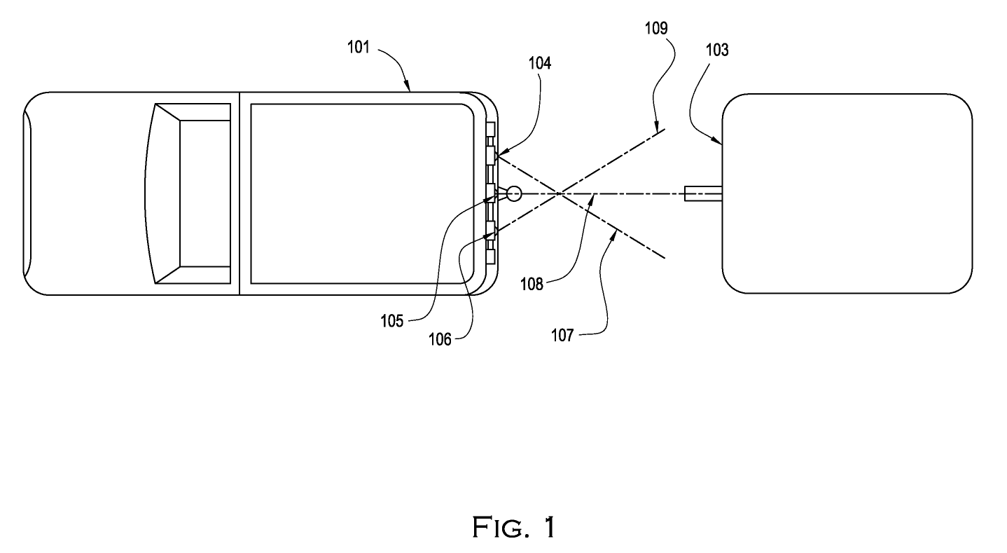

FIG. 1 shows a system for aligning a vehicle 101 to an object. In a preferred embodiment the vehicle 101 may be a pick-up truck and the object to which it must be aligned may be a trailer. However, the vehicle 101 could be any device which is used to tow objects or which must be placed in specific alignment with another object. Examples of such vehicles 101 include, but are not limited to, semi tractors, cars, minivans, full-size vans, box trucks, sports utility vehicles, boats, forklifts, airplanes, and the like. The object to which the vehicle 101 must be aligned may include a trailer, a loading dock, a structure, or the like. As depicted in FIG. 1, the vehicle 101 must be aligned with the trailer so that the vehicle 101 can tow the trailer.

A first light source 105, a second light source 104, and a third light source 106 are attached to the vehicle 101. The first light source 105, second light source 104, and third light source 106 may be lasers, LED's, or the like. The first light source 105 may project a first image 108, the second light source 104 may project a second image 107, and the third light source 106 may project a third image 109 onto a reflecting surface 103. The reflecting surface 103 may be on the object to which the vehicle 101 is being aligned, a surface permanently or temporarily attached to the object to which the vehicle 101 is being aligned, a surface with a fixed position relative to the object to which the vehicle 101 is being aligned, or the like. In alternate embodiments, in which the light sources 104, 105, 106 are connected to the object to which the vehicle 101 is being aligned, the reflecting surface 103 may be on the vehicle 101 itself The projected images 107, 108, 109 may be lines, dots, geometric shapes, crosshairs, or the like and the projected images 107, 108, 109 may be constantly displayed or may be pulsed.

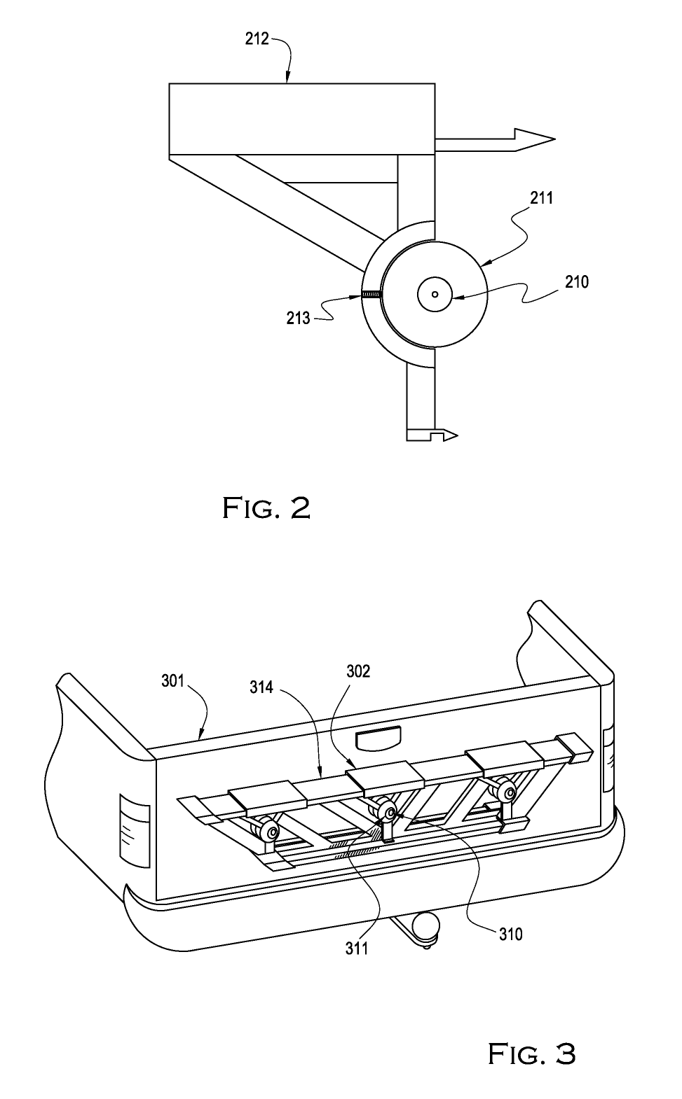

FIG. 2 shows a spherical bearing assembly half 212 which houses a sphere 211, into which a cylindrical light source 210 is mounted. The sphere 211 may be housed between two (2) spherical bearing assembly halves 212 which may be attached to one another to form a spherical bearing assembly 302. The spherical bearing assembly 302 may be how the first, second, and third light sources 105, 104, 106 are attached to the vehicle 101. Each spherical bearing assembly 302 may comprise two spherical bearing assembly halves 212. Each spherical bearing assembly half 212 may comprise half a hollow sphere with an opening through which light emitted by the cylindrical light source 210 may escape. Each spherical bearing assembly half 212 may further comprise mounting points which may enable the spherical bearing assembly 302 to be mounted to a vehicle 101 or to a mounting rod 314. In a preferred embodiment, each spherical bearing assembly half 212 may join with an identical spherical bearing assembly half 212 to form a hollow sphere which may provide a housing for a sphere 211 in which a cylindrical light source 210 may be mounted. Alternatively, the spherical bearing assembly half 212 may combine with another structure which creates a housing for a sphere 211 in which a cylindrical light source 210 may be mounted. Alternatively, the light sources 105, 104, 106 housed by the spherical bearing assembly 302 may be spherical or another shape well known in the art, which may be mounted in a sphere 211. When the spherical bearing assembly 302 is assembled to house a sphere 211 in which a cylindrical light source 210 may be mounted, a set screw 213 may be inserted and tightened through the housing to fix the direction in which the cylindrical light source 210 is aimed. In an alternate embodiment, a device or method other than a set screw 213 may be used to fix the direction in which the cylindrical light source 210 is aimed. These alternate devices and methods are well known in the art.

FIG. 3 depicts three spherical bearing assemblies 302 affixed to a mounting rod 314. Each spherical bearing assembly 302 houses a sphere 311 in which a cylindrical light source 310 is mounted. The mounting rod 314 may be attached to a vehicle 301. The spherical bearing assemblies 302 may be connected to the mounting rod 314 by a compression fit, screws, epoxy, welding, or the like. Additionally, the spherical bearing assemblies 302 may be an integral part of the mounting rod 314. The roll, pitch, and yaw of the sphere 311 housed by the spherical bearing assembly 302 may be adjusted while the sphere 311 remains in its housing.

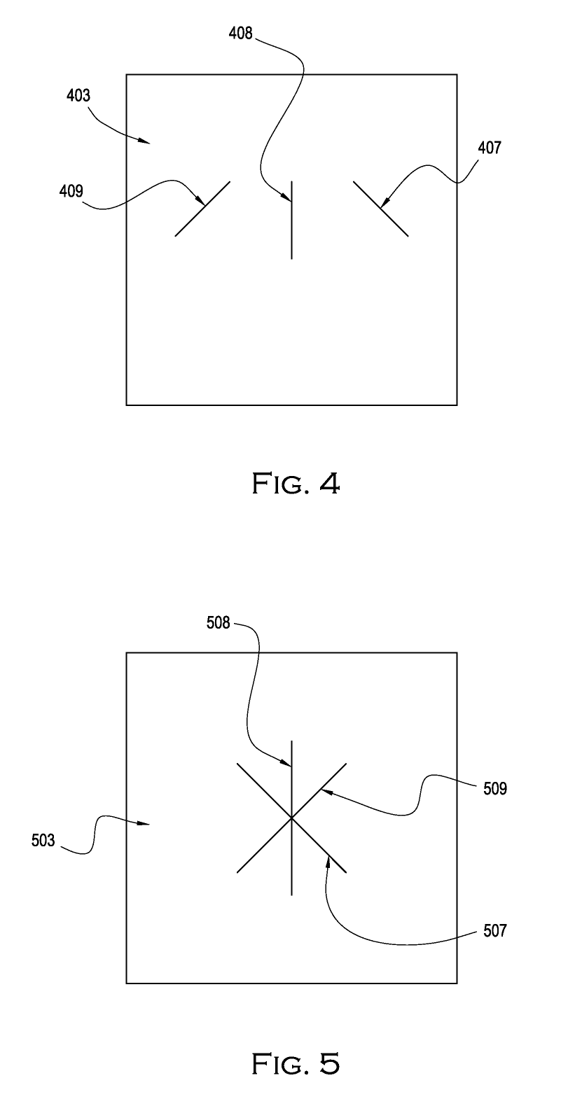

FIG. 4 depicts a first image 408, a second image 407, and a third image 409 on a reflecting surface 403. In a preferred embodiment, the first image 408, second image 407, and third image 409 may be lines. As depicted in FIG. 4 the first image 408, second image 407, and third image 409 have not converged. In use, if the first image 408, second image 407, and third image 409 appear as depicted in FIG. 4, the driver of the vehicle 101 knows that the vehicle 101 is not in desired alignment with the object. As the vehicle 101 approaches the object to which it is to be aligned, the first image 408, second image 407, and third image 409 will converge. In the case shown in FIG. 4, the images 407, 408, 409 are lines and they converge and intersect at a single point to signal the driver that the vehicle is in desired alignment.

FIG. 5 depicts an example of a predetermined configuration which the first image 508, second image 507, and third image 509 may form on the reflecting surface 503 when the vehicle 101 is properly aligned with the object. The predetermined configuration must also be displayed when the system is initially calibrated.

To calibrate the system, the vehicle 101 and the object must be positioned in desired alignment. The desired alignment is the relative position between the vehicle 101 and the object which is sought by the operator of the vehicle 101. In the case where the object is a trailer, the desired alignment may be the relative positioning of the vehicle 101 and the trailer which allows the trailer to be hitched to the vehicle 101. In the case where the object is a loading dock, the desired alignment may be the relative positioning of the vehicle 101 and the loading dock which allows optimal access to the vehicle 101 from the loading dock.

In a preferred embodiment, the vehicle may have a first light source 105, a second light source 104, and a third light source 106 attached to the rear bumper of the vehicle 101. In alternate embodiments, the first light source 105, second light source 104, and third light source 106 may be attached to other positions of the vehicle 101 such as, for example, behind the rear window of a pick-up truck, on the stern of a boat, on the roof of a vehicle, along one side of a vehicle, or the like. Alternatively, the light sources 104, 105, 106 may be attached to the object to which the vehicle 101 is to be aligned and the images 107, 108, 109 may converge on a reflecting surface 103 attached to the vehicle 101. While the vehicle 101 and object are in desired alignment, the first light source 105, second light source 104, and third light source 106 may be adjusted such that the first image 108 projected by the first light source 105 appears at a first desired position on the reflecting surface 103, the second image 107 projected by the second light source 104 appears at a second desired position on the reflecting surface 103, and the third image 109 projected by the third light source 106 appears at a third desired position on the reflecting surface 103. The first, second, and third desired positions may be chosen such that the combination of each image forms a predetermined configuration which may visually indicate to the driver of the vehicle 101 that the vehicle 101 and the object are in desired alignment.

In a preferred embodiment, the first light source 105 may be connected to the centerline of the vehicle 101. This may aid in use of the laser line convergence vehicle alignment system because placing the first light source 105 on the vehicle 101 centerline may make it easier for the operator of the vehicle 101 to properly position the vehicle 101 in relation to the object. However, there may be instances in which the laser line convergence vehicle alignment system may not perform optimally if the first light source 105 is placed on the centerline of the vehicle 101. In these instances, it may be preferred to place the first light source 105 offset from the centerline of the vehicle 101. For example, a large truck backing up to a loading dock may prefer to mount the first light source 105, second light source 104, and third light source 106 on the driver's side of the truck in a vertical configuration with the light sources 104, 105, 106 in the same vertical plane. This may enable the driver to use side view mirrors to see the images 107, 108, 109 converge on the reflecting surface 103. Such a placement of the light sources 104, 105, 106 may be beneficial because the truck may obstruct the driver's view of the images 107, 108, 109 if the light sources 104, 105, 106 are mounted on the rear of the vehicle.

In a preferred embodiment, the second light source 104 may be attached to the vehicle 101 at a position offset to the right of the vehicle 101 centerline and the third light source 106 may be attached to the vehicle 101 at a position offset to the left of the vehicle 101 centerline. The distance between the centerline and the second light source 104 may be the same as the distance between the third light source 106 and the centerline. This may allow the second image 107 and the third image 109 to converge at the same rates and aid the operator of the vehicle 101 in aligning to the object.

In a preferred embodiment, the first light source 105, second light source 104, and third light source 106 may be secured to a mounting rod 314 with a non-adjustable distance between the first light source 105, second light source 104, and third light source 106. This mounting rod may be mounted to the vehicle 101 with the first light source 105 positioned on the centerline of the vehicle 101 or the mounting rod may be positioned on the vehicle with the first light source 105 offset from the centerline of the vehicle 101.

In a preferred embodiment, the position of the first light source 105, the second light source 104, or the third light source 106 may be rotatably adjusted. The first light source 105, the second light source 104, or the third light source 106 may be rotatably attached to the vehicle. The light sources are rotatably attached when the roll, pitch, and yaw 104, 105, 106 of the light sources may be adjusted without detaching the light sources 104, 105, 106. This may be done by loosening the set screw 213 in a spherical bearing assembly 302 and adjusting the roll, pitch, and yaw of the sphere 311 housed by the spherical bearing assembly 302. In embodiments which do not contain a set screw 213, the light sources may be rotatably adjusted by any mechanism which allows the roll, pitch, and yaw of the light source to be adjusted.

In a preferred embodiment the first light source 105, the second light source 104, and the third light source 106 may be adjustably attached to the mounting rod 314. The light sources 104, 105, 106 are adjustably attached to the mounting rod 314 when the position of the projected images 107, 108, 109 on the reflecting surface 103 may be adjusted without disconnecting the light sources 104, 105, 106 from the mounting rod 314.

While the above description contains much specificity, these should not be construed as limitations on the scope of any embodiment, but as exemplifications of the presently preferred embodiments thereof. Many other ramifications and variations are possible within the teachings of the various embodiments.

Thus the scope of the invention should be determined by the appended claims and their legal equivalents, and not by the examples given.

What is claimed is:

1. A method for calibrating a vehicle alignment system comprising the steps of:
positioning a vehicle in desired alignment with an object having a reflecting surface;
attaching to said vehicle a first light source capable of projecting a first image;
attaching to said vehicle a second light source capable of projecting a second image;
attaching to said vehicle a third light source capable of projecting a third image;
adjusting position of said first light source such that said first image appears at a first desired position on said reflecting surface;
adjusting position of said second light source such that said second image appears at a second desired position on said reflecting surface; and
adjusting position of said third light source such that said third image appears at a third desired position on said reflecting surface, wherein said first image, said second image, and said third image form a predetermined configuration when said vehicle is in said desired alignment with said object.

2. The method of claim 1, wherein said step of attaching to said vehicle a first light source capable of projecting a first image further comprises the step of:
attaching said first light source to a centerline of said vehicle.

3. The method of claim 1, wherein said step of attaching to said vehicle a second light source capable of projecting a second image further comprises the step of:
attaching said second light source to said vehicle offset a distance to the right of a centerline of said vehicle; and
wherein said step of attaching to said vehicle a third light source capable of projecting a third image further comprises the step of attaching said third light source to said vehicle offset said distance to the left of said centerline of said vehicle.

4. The method of claim 1, wherein said step of adjusting position of said first light source such that said first image appears at a first desired position on said reflecting surface further comprises the step of:
rotatably adjusting position of said first light source; and
wherein said step of adjusting position of said second light source such that said second image appears at a second desired position on said reflecting surface further comprises the step of rotatably adjusting position of said second light source; and
wherein said step of adjusting position of said third light source such that said third image appears at a third desired position on said reflecting surface, wherein said first image, said second image, and said third image form a predetermined configuration when said vehicle is in said desired alignment with said object further comprises the step of rotatably adjusting position of said third light source.

5. A system for aligning a vehicle to an object comprising:
a reflecting surface positioned relative to said object;
a first light source capable of projecting a first image, said first light source attached to said vehicle and positioned such that said first image is displayed on said reflecting surface when said vehicle and said object are in desired alignment with one another;
a second light source capable of projecting a second image, said second light source attached to said vehicle wherein said second light source is positioned such that said second image is displayed on said reflecting surface and said first image and said second image converge when said vehicle and said object are in said desired alignment with one another; and
a third light source capable of projecting a third image, said third light source attached to said vehicle wherein said third light source is positioned such that said third image is displayed on said reflecting surface and said first image, said second image, and said third image converge to form a predetermined configuration when said vehicle and said object are in said desired alignment with one another.

6. The system in claim 5, wherein said first light source is located on a centerline of said vehicle.

7. The system in claim 5, wherein said second image comprises a first line or a first crosshair.

8. The system in claim 7, wherein said third image comprises a second line or a second crosshair.

9. The system in claim 5, wherein said second light source and said third light source are rotatably attached to said vehicle.

10. The system in claim 5, wherein said second light source and said third light source are mounted in spherical bearing assemblies.

11. The system in claim 8, wherein said second light source and said third light source are mounted in spherical bearing assemblies.

12. A system for aligning a vehicle to an object comprising:
a first light source capable of projecting a first image wherein said first light source is adjustably attached to a mounting rod wherein said mounting rod is capable of attaching to said vehicle;
a second light source capable of projecting a second image wherein said second light source is adjustably attached to said mounting rod; and
a third light source capable of projecting a third image wherein said third light source is adjustably attached to said mounting rod wherein said first image, said second image, and said third image may converge to form a predetermined configuration when said vehicle and said object are in desired alignment with one another.

13. The system of claim 12, further comprising:
a reflecting surface upon which said first image, said second image, and said third image may converge to said predetermined configuration when said vehicle is in said desired alignment with said object.

14. The system in claim 12, wherein said first light source is located on a centerline of said vehicle.

15. The system in claim 12, wherein said second image comprises a first line or a first crosshair.

16. The system in claim 15, wherein said third image comprises a second line or a second crosshair.

17. The system in claim 12, wherein said first light source is rotatably attached to said mounting rod.

18. The system in claim 12, wherein said second light source and said third light source are rotatably attached to said mounting rod.

19. The system in claim 12, wherein said second light source and said third light source are mounted in spherical bearing assemblies.

20. The system in claim 16, wherein said second light source and said third light source are mounted in spherical bearing assemblies.
